(19) United States
(12) Patent Application Publication
(10) Pub. No.: US 2025/0184176 A1
(43) Pub. Date: Jun. 5, 2025

(54) POE TO USB-C MULTIPORT SWITCH

(71) Applicant: PHIHONG TECHNOLOGY CO., LTD., Taoyuan City (TW)

(72) Inventors: Joseph DaSilva, Bohemia, NY (US); Richard Frosch, Bohemia, NY (US)

(21) Appl. No.: 18/526,684

(22) Filed: Dec. 1, 2023

(51) Int. Cl. H04L 12/40; G06F 13/38; H04L 12/10

(52) U.S. Cl. CPC H04L 12/40045; G06F 13/387; H04L 12/10; G06F 2213/0042

(57) ABSTRACT

A power over Ethernet (PoE) to USB-C multiport switch, which includes a PoE interface to receive and transmit PoE power and Ethernet data, multiple USB-C ports to receive and transmit USB-C power and data, and a multiport Ethernet switch configured to receive the Ethernet data from the PoE interface and then distribute to the multiple USB-C ports and vice versa. Each USB-C port incorporates an Ethernet to USB-C data converter and a USB-C PD controller to negotiate power with power device by controlling a power converter. The Ethernet to USB-C data converter transposes the Ethernet data from the PoE interface to the USB-C port and vice versa and converts incoming Ethernet data into USB-C data formats and vice versa, the power converter converts PoE voltage to fit USB-C voltage, and the USB-C PD controller manages conversion of PoE power signal into a power charging signal for the USB-C port.

### TECHNICAL FIELD

The present invention relates to technology field of powering multiple Universal Serial Bus Type-C (USB-C) devices via Power over Ethernet (PoE) connection, and more particularly, a PoE to USB-C multiport switch.

### BACKGROUND

As the number of home terminals, monitoring equipment, and enterprise network communication products increases, there is a growing trend of opting for system power supply through network cables. This choice eliminates the need for AC adapters, avoiding any associated inconveniences. Consequently, the utilization of Ethernet technology is set to expand further. The devices facilitating this power supply and power reception are referred to as PoE equipment, which stands for Power over Ethernet. PoE technology enables the secure transmission of electrical power alongside data through Ethernet cables or lines.

USB technology was originally developed as a bus to establish connections between computers and electronic devices, serving both communication and power purposes. Over time, USB has replaced various computer interfaces like serial and parallel ports. Additionally, it has evolved to serve as a power charger for portable devices. The more recent USB-C connectors offer high data transfer rates and fast power delivery.

The future desktop will contain multiple devices that are powered over USB-C. The ideal desktop is powered via PoE from the wall and then using proposed device that power and data will be distributed across a multiport PoE to USB-C switch. Use the existing PoE network connection to charge multiple USB-C powered devices such as a notebook, Ultrabook or tablet can offer a new type of product.

The proposed solutions involve the utilization of a PoE to USB-C multiport switch, enabling the provision of power and data distribution across the PoE to multiport switch via one PoE source. This innovation is capable of powering multiple USB-C devices via single PoE connection while eliminating additional adaptors and cables.

### SUMMARY OF THE INVENTION

In one aspect of the present invention, a PoE to USB-C multiple switch is provided. This switch provides the ability of powering multiple USB-C devices via single PoE connection and consists of the following components:

1. PoE Interface: This interface is responsible for receiving and transmitting PoE signals, which contain PoE power and Ethernet data.

2. Multiple USB-C Interfaces (ports): These interfaces handle the reception and transmission of USB-C signals, containing USB-C power and USB-C data.

3. Multiport Ethernet switch: Positioned between the PoE interface and the multiple USB-C ports, this switch receives the Ethernet data from the PoE interface and then distribute to the multiple USB-C ports and vice versa.

4. Ethernet to USB-C Data Converter: Integrated with each USB-C Interface, this converter transposes the Ethernet data from the PoE interface to the USB-C interface, and vice versa. It accomplishes this by determining the communication protocol between the two interfaces and processing incoming Ethernet data signals into USB-C data formats and vice versa.

4. Power Converter: Integrated with each USB-C Interface, this power converter steps down the PoE voltage to match the USB-C voltage.

5. USB-C Power Delivery Controller: This Controller is also integrated with each USB-C Interface. Its primary role is to manage the conversion of the PoE power signal from a PoE source into a power charging signal for the USB-C interface.

In one preferred embodiment, the power over Ethernet (PoE) to USB-C multiport switch further includes a supervisory microcontroller unit to control components activated depending on direction of power flow.

In one preferred embodiment, the power over Ethernet (PoE) to USB-C multiport switch further includes a PoE splitter disposed between the PoE interface and the multiport Ethernet switch to act as a power and data splitter.

In one preferred embodiment, the power over Ethernet (PoE) to USB-C multiport switch further includes a PoE interface controller disposed between the PoE splitter and the plurality of USB-C ports, configured to negotiate with a PoE switch or a midspan to ensure the powering solution is IEEE 802.3 POE standards compliant and incorporate all of the functions for a PoE system including detection, classification and inrush current limiting.

In one preferred embodiment, the PoE interface controller is a microcontroller unit (MCU); the PoE interface is a RJ45 interface; the Ethernet to USB-C data converter is a data conversion chipset; and the Ethernet to USB-C data converter controls data transfer up to and including 10 Gb/s.

In one preferred embodiment, the power converter includes flyback converter, half bridge converter, full bridge converter, buck converter, boost converter, or the like.

In one preferred embodiment, the USB-C PD controller is a USB-C PD microcontroller IC.

According to another aspect of the present invention, a power over Ethernet (PoE) to USB-C multiport switch is proposed, which comprises a PoE interface to receive and transmit PoE signals containing PoE power and Ethernet data, a plurality of USB-C ports to receive and transmit USB-C signals containing USB-C power and USB-C data, a multiport Ethernet switch coupled between the PoE interface and the plurality of USB-C ports, configured to receive the Ethernet data from the PoE interface and then distribute to the multiple USB-C ports and vice versa, and a PoE splitter disposed between the PoE interface and the multiport Ethernet switch, configured to act as a power and data splitter. Each USB-C port incorporates an Ethernet to USB-C data converter and has a USB-C power delivery (PD) controller used to control a power converter, the Ethernet to USB-C data converter is coupled between the PoE interface and the USB-C port, configured to transpose the Ethernet data from the PoE interface to the USB-C port and vice versa by determining communication protocol between the PoE interface and the USB-C interface and processing incoming Ethernet data signals into USB-C data formats and vice versa, the power converter is coupled between the PoE interface and the USB-C port, used to step down PoE voltage to fit USB-C voltage, and the USB-C power delivery (PD) controller is connected between the power converter and the USB-C port, configured to manage conversion of PoE power signal from a PoE source into a power charging signal for the USB-C port.

In one preferred embodiment, the power over Ethernet (PoE) to USB-C multiport switch further includes a supervisory microcontroller unit to control components activated depending on direction of power flow.

In one preferred embodiment, the power over Ethernet (PoE) to USB-C multiport switch further includes a PoE interface controller disposed between the PoE splitter and the plurality of USB-C ports, configured to negotiate with a PoE switch or a midspan to ensure the powering solution is IEEE 802.3 POE standards compliant and incorporate all of the functions for a PoE system including detection, classification and inrush current limiting.

In one preferred embodiment, the PoE interface controller is a microcontroller unit (MCU); the PoE interface is a RJ45 interface; the Ethernet to USB-C data converter is a data conversion chipset; and the Ethernet to USB-C data converter controls data transfer up to and including 10 Gb/s.

In one preferred embodiment, the power converter includes flyback converter, half bridge converter, full bridge converter, buck converter, boost converter, or the like.

In one preferred embodiment, the USB-C PD controller is a USB-C PD microcontroller IC.

### BRIEF DESCRIPTION OF THE DRAWINGS

The components, features and advantages of the present invention will be elucidated through detailed descriptions of the preferred embodiments outlined in the specification and the accompanying drawings:

FIG. 1 illustrates a schematic representation of the PoE to USB-C multiport switch according to one preferred embodiment of the present invention.

FIG. 2 presents a schematic block diagram of the PoE to USB-C multiport switch circuit in accordance with one preferred embodiment of the present invention.

FIG. 3 presents a schematic diagram of an individual USB-C port in accordance with one preferred embodiment of the present invention

### DETAILED DESCRIPTION

We will now delve into the detailed descriptions of some preferred embodiments of the present invention. However, it is important to note that these preferred embodiments are provided for illustrative purpose and do not impose limitations on the scope of the present invention. The present invention can be implemented in various other embodiments beyond those explicitly described herein, and its scope is determined solely by the accompanying claims.

Within the present invention, a PoE to USB-C multiport switch is proposed to convert Ethernet data to USB-C and vice versa and to divide up IEEE 802.3 BT PoE to smaller power levels for powering devices, such as mobile phone, laptop, Ipad, monitor, etc., via USB-C.

The PoE to USB-C multiport switch is constructed with single PoE input port and multiple USB-C ports each delivering a predetermined value of USB-C power. The PoE to USB-C multiport switch circuit uses a multiport Ethernet switch to distribute the incoming PoE data to the proper USB-C port, while each USB-C port has a Ethernet to USB-C data conversion chipset and a power delivery (PD) controller to negotiate power with the connected powered device and utilizes a power converter having buck/boost topology for power conversion to buck down the PoE voltage to USB-C levels.

In other alternatives, the power converter can employ different topologies that converts power from one form to another, ensuring the PoE voltage is stepped down to match the USB-C voltage, such as flyback converter, half-bridge converter, full-bridge converter, buck converter, LLC converter or the like.

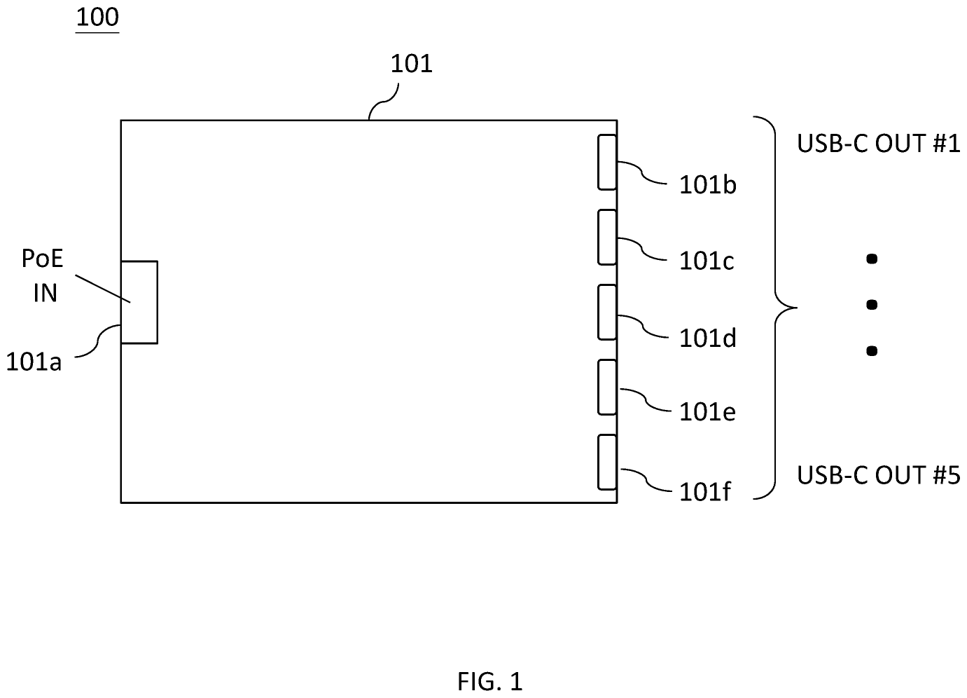

FIG. 1 depicts a schematic drawing of the PoE to USB-C multiport switch 100, illustrating the transfer of power from a single PoE port to multiple USB-C ports and the bidirectional data transfer between the PoE port to the multiple USB-C ports. As shown in FIG. 1, in one embodiment, the PoE to USB-C multiport switch 100 comprises a casing 101, which includes at least a PoE port 101a and multiple USB-C ports (101b, 101c, 101d, 101e, 101f). The PoE port 101a is configured to receive a PoE plug from a PoE cable, while each of the multiple USB-C ports is configured to receive USB-C connector plug. The casing 101 also houses internal electronic components that can be assembled onto a PCB board to establish electrical connection between the PoE port 101a and the multiple USB-C ports (101b, 101c, 101d, 101e, 101f).

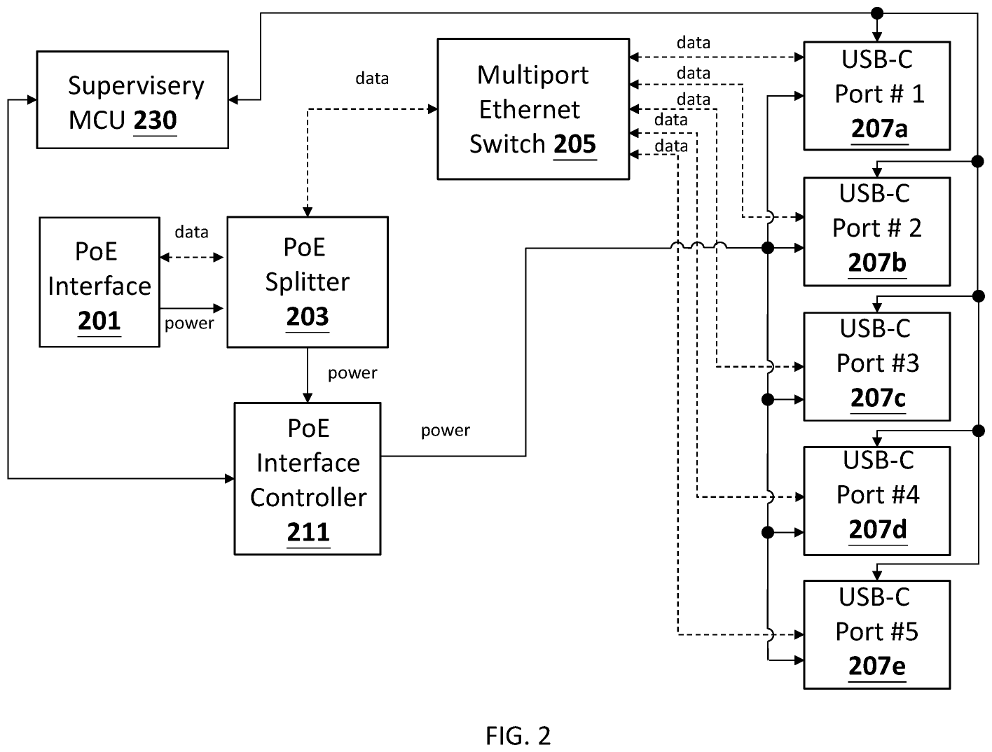

Please refer to FIG. 2 for a schematic block diagram of the PoE to USB-C multiport switch circuit 200 in an exemplary embodiment. Initially, the circuit manages the power and data flow from PoE to multiple USB-C ports. Usual PoE signals, carrying both power and data, are delivered to the PoE to USB-C multiport switch circuit 200 via a PoE interface 201. The combined data and power delivered from the PoE interface 201 are separated by a PoE splitter 203. The data pathway within the circuit 200 involves transmission via the PoE interface 201 to the PoE splitter 203, subsequently to the multiport Ethernet switch 205 and then distributing to the multiple USB-C ports (207a, 207b, 207c, 207d, 207e).

In certain embodiments, the multiport Ethernet switch 205 can receive data from the PoE interface 201 and then distribute to the multiple USB-C ports (207a, 207b, 207c, 207d, 207e) or receive data through multiple data channels from the multiple USB-C ports (207a, 207b, 207c, 207d, 207e), then merge and send these data from the multiple data channels to the PoE interface.

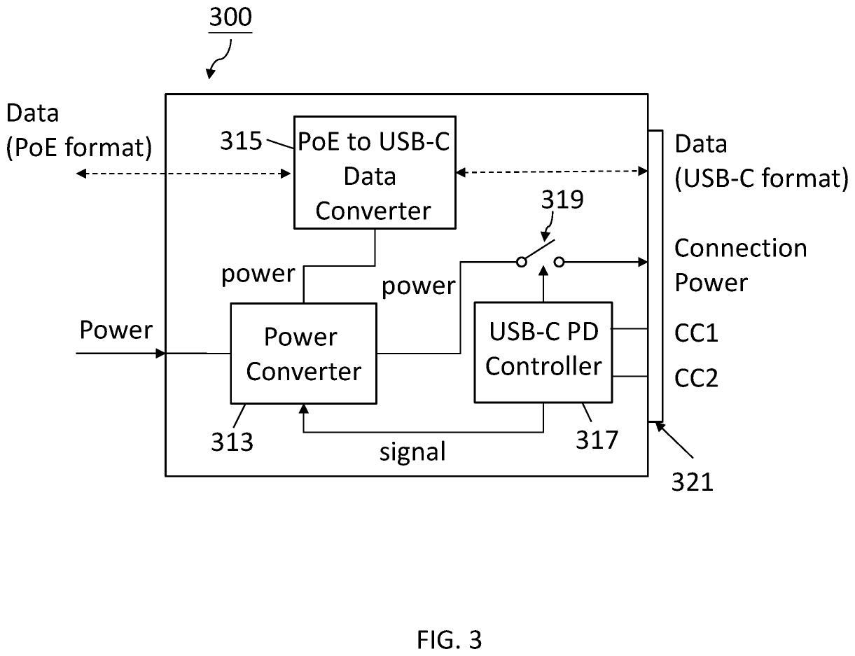

The power pathway in the circuit 200 typically converts PoE input signals into power signals, taking into account the source device's characteristics. Along this power path, between the PoE splitter 203 and the multiple USB-C ports (207a, 207b, 207c, 207d, 207e), the circuit may include a PoE interface controller 211, each USB-C port of the circuit 200 incorporates a Ethernet to USB-C data conversion chipset and has a USB-C power delivery (PD) controller to negotiate power with the connected powered devices. Details of each USB-C port will be discussed in FIG. 3 and related descriptions.

In some embodiments, the PoE interface controller 211, which may be a PoE interface MCU, that may negotiate with PoE switch or a midspan to ensure the powering solution is IEEE 802.3 POE standards compliant, which may include IEEE 802.3af/at (15.4 Watts), IEEE 802.3bt (30 Watts) and next generation IEEE 802.3 POE (>100 Watts) compliant and can incorporate all of the functions for a PoE system including detection, classification and inrush current limiting.

In some embodiments, the PoE splitter 203 may split the power to the PoE interface controller 211 leading to the multiple USB-C ports (207a, 207b, 207c, 207d, 207e) and the data to the multiport Ethernet switch 205.

In some embodiments, the PoE voltage will be stepped down to fit the USB-C levels by using the power converter that is incorporated with each USB-C port, detail will be discussed in FIG. 3 and related descriptions.

In some embodiments, a supervisory MCU 230 may need to be used to control components activated depending on direction of power flow.

Please refer to FIG. 3, a schematic block diagram of an individual USB-C port 300 is shown. In one embodiment, each USB-C port of the PoE to multiple USB-C switch may include a power converter 313, an Ethernet to USB-C data converter 315 and a USB-C power delivery (PD) controller 317. The power converter 313 converts the incoming PoE voltage to match the USB-C voltage while an external USB-C powered device is sensed, via CC1 and CC2 terminals of the USB-C interface 321, to request power transferring from the PoE power source, the USB-C PD controller 317 is configured to active a switching device 319 dispose between the power converter 313 and the USB-C interface 321 to establish power delivery path between the power converter 313 and the external USB-C powered device. The Ethernet to USB-C data converter 315 is positioned between the multiport Ethernet switch 205 (see FIG. 2) and the USB-C interface 321 and is configured to process incoming PoE data distributed by the multiport Ethernet switch 205 (see FIG. 2) into USB-C data formats and vice versa.

In some embodiments, the Ethernet to USB-C data converter 315 may include a data conversion chipset to transpose the data from Ethernet to USB and vice versa, which determines the communication protocols between the PoE interface (RJ45 interface) and the USB-C interface. Once the protocol is determined, the Ethernet to USB-C data converter 205 processing incoming Ethernet data signals into USB-C data formats and vice versa. The output of the Ethernet to USB-C data converter 315 may coupled to the USB-C interface 321 (USB-C connector). The Ethernet to USB-C data converter 315 may control data transfer up to 10 Gb/s. In some embodiments, the power converter 313 may connect to the Ethernet to USB-C data converter 315. The Ethernet to USB-C data converter 315 may communicate to the USB-C device coupled to the USB-C interface 321 via the CC1 and CC2 terminals.

In some embodiments, the USB-C PD controller 317 is configured to negotiate a device charging mode, for example constant voltage (CV), constant current (CC) or trickle charging mode, between a USB-C device connected to the USB-C interface 321 and a PoE source connected to the PoE interface 201 (see FIG. 2), and to manage conversion of PoE power signal from the PoE source into a power charging signal for the USB-C device.

In certain embodiments, the USB-C PD controller 317 is a USB-C controller IC.

In certain embodiments, the USB-C PD controller 317 is a microcontroller unit (MCU).

In some embodiments, the USB-C interface 321, i.e. USB-C connector, is configurable to provide the Ethernet signals converted into the USB-C formats as readable data and charging power to the USB-C device.

While we have described various embodiments of the present invention, it is important to note that these are presented as examples and not limitations. The present invention can be practiced in a wide range of other embodiments beyond those explicitly described, and the scope of the invention is exclusively defined by the accompanying claims.

What is claimed is:

1. A power over Ethernet (PoE) to USB-C multiport switch, comprising:
a PoE interface to receive and transmit PoE signals containing PoE power and Ethernet data;
a plurality of USB-C ports to receive and transmit USB-C signals containing USB-C power and USB-C data;
a multiport Ethernet switch coupled between said PoE interface and said plurality of USB-C ports, configured to receive said Ethernet data from said PoE interface and then distribute to said multiple USB-C ports and vice versa; and
wherein each USB-C port of said plurality of USB-C ports incorporates an Ethernet to USB-C data converter and has a USB-C power delivery (PD) controller to control a power converter, said Ethernet to USB-C data converter being coupled between said PoE interface and said USB-C port to transpose said Ethernet data from said PoE interface to said USB-C port and vice versa by determining communication protocol between said PoE interface and said USB-C interface and processing incoming Ethernet data signals into USB-C data formats and vice versa, said power converter being coupled between said PoE interface and said USB-C port to step down PoE voltage to fit USB-C voltage, and said USB-C power delivery (PD) controller being connected between said power converter and said USB-C port to manage conversion of PoE power signal from a PoE source into a power charging signal for said USB-C port.

2. The power over Ethernet (PoE) to USB-C multiport switch of claim 1, further including a supervisory microcontroller unit to control components activated depending on direction of power flow.

3. The power over Ethernet (PoE) to USB-C multiport switch of claim 1, further including a PoE splitter disposed between said PoE interface and said multiport Ethernet switch to act as a power and data splitter.

4. The power over Ethernet (PoE) to USB-C multiport switch of claim 3, further including a PoE interface controller disposed between said PoE splitter and said plurality of USB-C ports, configured to negotiate with a PoE switch or a midspan to ensure a powering solution is IEEE 802.3 POE standards compliant and incorporate functions for a PoE system including detection, classification and inrush current limiting.

5. The power over Ethernet (PoE) to USB-C multiport switch of claim 4, wherein said PoE interface controller is a microcontroller unit (MCU).

6. The power over Ethernet (PoE) to USB-C multiport switch of claim 1, wherein said PoE interface is a RJ45 interface.

7. The power over Ethernet (PoE) to USB-C multiport switch of claim 1, wherein said Ethernet to USB-C data converter is a data conversion chipset.

8. The power over Ethernet (PoE) to USB-C multiport switch of claim 7, wherein said Ethernet to USB-C data converter controls data transfer up to and including 10 Gb/s.

9. The power over Ethernet (PoE) to USB-C multiport switch of claim 1, wherein said power converter includes flyback converter, half bridge converter, full bridge converter, buck converter, boost converter, or the like.

10. The power over Ethernet (PoE) to USB-C multiport switch of claim 1, wherein said USB-C PD controller is a USB-C PD microcontroller IC.

11. A power over Ethernet (PoE) to USB-C multiport switch, comprising:
a PoE interface to receive and transmit PoE signals containing PoE power and Ethernet data;
a plurality of USB-C ports to receive and transmit USB-C signals containing USB-C power and USB-C data;
a multiport Ethernet switch coupled between said PoE interface and said plurality of USB-C ports, configured to receive said Ethernet data from said PoE interface and then distribute to said multiple USB-C ports and vice versa;
a PoE splitter disposed between said PoE interface and said multiport Ethernet switch, configured to act as a power and data splitter; and
wherein each USB-C port of said plurality of USB-C ports incorporates an Ethernet to USB-C data converter and has a USB-C power delivery (PD) controller to control a power converter, said Ethernet to USB-C data converter being coupled between said PoE interface and said USB-C port, to transpose said Ethernet data from said PoE interface to said USB-C port and vice versa by determining communication protocol between said PoE interface and said USB-C interface and processing incoming Ethernet data signals into USB-C data formats and vice versa, said power converter being coupled between said PoE interface and said USB-C port to step down PoE voltage to fit USB-C voltage, and said USB-C power delivery (PD) controller being connected between said power converter and said USB-C port to manage conversion of PoE power signal from a PoE source into a power charging signal for said USB-C port.

12. The power over Ethernet (PoE) to USB-C multiport switch of claim 11, further including a supervisory microcontroller unit to control components activated depending on direction of power flow.

13. The power over Ethernet (PoE) to USB-C multiport switch of claim 11, further including a PoE interface controller disposed between said power and data splitter/combiner and said bidirectional power converter, configured to negotiate with a PoE switch or a midspan to ensure a powering solution is IEEE 802.3 POE standards compliant and incorporate functions for a PoE system including detection, classification and inrush current limiting.

14. The power over Ethernet (PoE) to USB-C multiport switch of claim 13, wherein said PoE interface controller is a microcontroller unit (MCU).

15. The power over Ethernet (PoE) to USB-C multiport switch of claim 11, wherein said PoE interface is a RJ45 interface.

16. The power over Ethernet (PoE) to USB-C multiport switch of claim 11, wherein said Ethernet to USB-C data converter controls data transfer up to and including 10 Gb/s.

17. The power over Ethernet (PoE) to USB-C multiport switch of claim 11, wherein said Ethernet to USB-C data converter is a data conversion chipset.

18. The power over Ethernet (PoE) to USB-C multiport switch of claim 13, wherein said power converter includes flyback converter, half bridge converter, full bridge converter, buck converter, boost converter, or the like.

19. The power over Ethernet (PoE) to USB-C multiport switch of claim 11, wherein said USB-C PD controller is a USB-C PD microcontroller IC.
